(19) United States
(12) Patent Application Publication
(10) Pub. No.: US 2019/0018445 A1
(43) Pub. Date: Jan. 17, 2019

(54) PORTABLE ELECTRONIC APPARATUS, CONTROL METHOD, AND PROGRAM

(71) Applicant: SEIKO EPSON CORPORATION, Tokyo (JP)

(72) Inventors: Ken WATANABE, Matsumoto-shi (JP); Hidekazu MAEZAWA, Shiojiri-shi (JP); Ikuo HAYAISHI, Asahi-mura (JP)

(73) Assignee: SEIKO EPSON CORPORATION, Tokyo (JP)

(21) Appl. No.: 16/033,625

(22) Filed: Jul. 12, 2018

(30) Foreign Application Priority Data
Jul. 14, 2017 (JP) 2017-137776

(51) Int. Cl. G06F 1/16; G06F 3/01; H04M 1/725; G06K 9/00; G06F 3/041; G01S 19/39

(52) U.S. Cl. CPC G06F 1/163; G06F 3/011; G01S 19/39; G06K 9/00335; G06F 3/0412; H04M 1/72552

(57) ABSTRACT

A portable electronic apparatus includes an electrophoretic panel, a body motion sensor that detects motion of a user, and outputs a body motion signal, a communication unit that receives a communication signal from an external apparatus, and a processing circuit that is electrically connected to the electrophoretic panel, the body motion sensor, and the communication unit, in which the processing circuit performs a refreshing process on the electrophoretic panel on the basis of either of the body motion signal and the communication signal.

This application claims the benefit of priority from Japanese Patent Application No. 2017-137776 filed Jul. 14, 2017, the entire contents of which are incorporated herein by reference.

### BACKGROUND

### 1. Technical Field

The present disclosure relates to a portable electronic apparatus, a control method, and a program.

### 2. Related Art

There is an electrophoretic panel as a kind of a so-called electronic paper display panel. For example, JP-A-2012-211922 discloses an electronic timepiece including an electrophoretic display (EPD) device; a power generation detection circuit detecting a power generation state of a solar battery; a timer measuring non-power generation duration during which the power generation state cannot be detected by the power generation detection circuit; and a display control circuit controlling the EPD device. In the electronic timepiece, in a case where the non-power generation duration measured by the timer exceeds a predetermined setting time, the display control circuit makes the EPD device indicate a state of saving power and increases intervals of refreshing operation of display.

However, in a case where an electrophoretic panel is used as a display panel, deterioration in the electrophoretic panel progresses according to the number of times of update, and thus there is concern that the deterioration may nonuniformly progress in a screen of the electrophoretic panel. For example, in time display, since an update frequency of a second is higher than an hour or a minute, deterioration in a display region of the second progresses faster than other display regions, and thus there is concern that the deterioration in the display region of the second may be conspicuous (for example, seen light gray). Screen refreshing is performed in order to remove screen afterimage of the electrophoretic panel, but there is concern that too frequent refreshing may give a user stress.

In recent years, in a watch type wearable apparatus, there is a restriction in battery capacitance in order to reduce a size of the apparatus, and thus study on achievement of low power consumption is necessary. There is an EPD as a display member with low power consumption, but, in a case where the EPD is used as a wearable device, a user interface is required to be designed in consideration of a response speed, the number of times of update, power consumption during update, and the like.

### SUMMARY

An advantage of some aspects of the invention is to solve at least a part of the problems described above, and the invention can be implemented as the following forms or application examples.

### APPLICATION EXAMPLE 1

A portable electronic apparatus according to this application example includes an electrophoretic panel; a body motion sensor that detects motion of a user, and outputs a body motion signal; a communication unit that receives a communication signal from an external apparatus; and a processing circuit that is electrically connected to the electrophoretic panel, the body motion sensor, and the communication unit, in which the processing circuit performs a refreshing process on the electrophoretic panel on the basis of either of the body motion signal and the communication signal.

According to this application example, it is possible to efficiently and effectively perform a refreshing process on the electrophoretic panel at a meaningful timing such that the user does not suffer from stress. In other words, a refreshing process on the electrophoretic panel is not performed at a timing not intended by the user. Consequently, it is possible to improve display quality without influencing display during viewing. In a case where the processing circuit is configured to perform a refreshing process on the basis of detection of either of a body motion signal and a communication signal, the refreshing process can suggest, for example, a determination result based on the body motion signal or reception of the communication signal to the user, and thus the refreshing process can be performed at a meaningful timing.

### APPLICATION EXAMPLE 2

In the portable electronic apparatus according to the application example, it is preferable that, in a case where a lap separation position is determined on the basis of the body motion signal, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. A movement distance is measured on the basis of a body motion signal, and, in a case where the movement distance exceeds a preset predetermined distance, for example, 1 km, the refreshing process can be performed. Consequently, the refreshing process can indicate a lap section end, and thus the refreshing process can be performed at a meaningful timing.

### APPLICATION EXAMPLE 3

In the portable electronic apparatus according to the application example, it is preferable that the communication signal includes at least any of reception of a call, reception of an electronic message, a notification of a schedule, and reception of music data, and, in a case where the communication unit receives the communication signal, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. The refreshing process is performed when a reception signal regarding at least one of reception of a call, reception of an electronic message, a notification of a schedule, and reception of music data is received, and thus the refreshing process can indicate notifying the user of reception of information, so that the refreshing process can be performed at a meaningful timing.

### APPLICATION EXAMPLE 4

In the portable electronic apparatus according to the application example, it is preferable that, in a case where it is determined that target information related to a workout performed by the user has been achieved on the basis of the body motion signal, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing.

The refreshing process is performed when target information regarding a workout performed by the user is achieved on the basis of the body motion signal, for example, when the user sets a target such as “8000 steps a day”, and the number of accumulated steps calculated on the basis of a body motion signal exceeds the target value, the refreshing process may be configured to be performed. Consequently, the refreshing process can indicate achievement of a target, and thus the refreshing process can be performed at a meaningful timing.

### APPLICATION EXAMPLE 5

In the portable electronic apparatus according to the application example, it is preferable that, in a case where it is determined that the portable electronic apparatus has transitioned to a movement state from a standing still state on the basis of the body motion signal, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. The refreshing process is performed when it is determined that the portable electronic apparatus transitions to a movement state from a standing still state, for example, when the portable electronic apparatus placed on a table is raised by the user, and thus the user can recognize that the portable electronic apparatus normally functions even if a screen of the portable electronic apparatus disappears in a sleep state, or is in a state in which the past screen is still displayed.

### APPLICATION EXAMPLE 6

In the portable electronic apparatus according to the application example, it is preferable that, in a case where it is determined that the portable electronic apparatus has been detached from the user's body on the basis of the body motion signal, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. The refreshing process is performed when it is determined that the portable electronic apparatus is detached from the body of the user on the basis of a body motion signal, it is possible to suggest that the portable electronic apparatus has recognized a change in a mounting state to the user.

### APPLICATION EXAMPLE 7

In the portable electronic apparatus according to the application example, it is preferable that, in a case where a change in a behavior type of the user is detected on the basis of the body motion signal, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. The refreshing process is performed when a change in a behavior type of the user is detected on the basis of the body motion signal, and thus it is possible to suggest that the portable electronic apparatus has recognized the change in a behavior type of the user to the user.

### APPLICATION EXAMPLE 8

It is preferable that the portable electronic apparatus according to the application example further includes a GNSS signal reception unit that receives a GNSS signal, and, in a case where measurement using the GNSS signal in the GNSS signal reception unit is possible, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. In a case where a refreshing process is configured to be performed when measurement using a GNSS signal is possible, the refreshing process can indicate notifying the user of a state of being capable of performing position measurement, and thus the refreshing process can be performed at a meaningful timing.

### APPLICATION EXAMPLE 9

It is preferable that the portable electronic apparatus according to the application example further includes a pulse sensor that measures a pulse signal, and, in a case where measurement of the pulse signal in the pulse sensor is possible, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. In a case where a refreshing process is configured to be performed when measurement of a pulse signal in the pulse sensor is possible, the refreshing process can indicate notifying the user of a state of being capable of performing pulse measurement, and thus the refreshing process can be performed at a meaningful timing.

### APPLICATION EXAMPLE 10

It is preferable that the portable electronic apparatus according to the application example further includes a charging terminal unit that is connected to a charger, and, in a case where it is determined that connection between the charging terminal unit and the charger has been canceled, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. In a case where a refreshing process is configured to be performed when the disconnection from the charger is determined, the refreshing process can indicate notifying the user of ending of a charging operation, and thus the refreshing process can be performed at a meaningful timing.

### APPLICATION EXAMPLE 11

It is preferable that the portable electronic apparatus according to the application example further includes a clock unit that measures time, and, in a case where a time point from the clock unit is the hour, or a split time is the hour, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. In a case where a refreshing process is configured to be performed when a time point from the clock unit is the hour, or a split time is the hour, the refreshing process can indicate notifying the user of a time point or separation of an elapsed time, and thus the refreshing process can be performed at a meaningful timing.

### APPLICATION EXAMPLE 12

It is preferable that the portable electronic apparatus according to the application example further includes an operation unit that receives an operation of the user, and outputs an operation signal, and, in a case where the operation signal from the operation unit is detected, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. In a case where the processing circuit is configured to perform a refreshing process when an operation signal from the operation unit is detected, the refreshing process can suggest that the processing circuit has detected the operation signal to the user, and thus the refreshing process can be performed at a meaningful timing.

### APPLICATION EXAMPLE 13

In the portable electronic apparatus according to the application example, it is preferable that, in a case where the operation signal corresponding to at least one of a menu screen transition operation and a lock function ON/OFF operation is detected, the processing circuit performs the refreshing process.

According this application example, it is possible to perform the refreshing process in a state in which at least one of a menu screen transition operation and a lock function ON/OFF operation is included. Consequently, it is possible to improve display quality without influencing display during viewing. In a case where the processing circuit is configured to perform a refreshing process when an operation signal corresponding to at least one of a menu screen transition operation and a lock function ON/OFF operation is detected, the refreshing process can suggest that the processing circuit has detected the operation signal to the user, and thus the refreshing process can be performed at a meaningful timing.

### APPLICATION EXAMPLE 14

In the portable electronic apparatus according to the application example, it is preferable that, when display of the electrophoretic panel is switched from a first screen to a second screen, the electrophoretic panel leaves at least a partial outline of an object included in the first screen, and displays the outline and the second screen.

According to this application example, a refreshing process timing and an area for performing screen switching can be reduced, and thus it is possible to reduce power consumption due to the refreshing process.

### APPLICATION EXAMPLE 15

In the portable electronic apparatus according to the application example, it is preferable that the processing circuit includes a content control unit, and, in a case where the content control unit detects a change from the first content to the second content, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing. In a case where the processing circuit is configured to perform a refreshing process when a change from the first content to the second content is detected by the content control unit, the refreshing process can suggest that a piece of music has been changed to the user, and thus the refreshing process can be performed at a meaningful timing.

### APPLICATION EXAMPLE 16

In the portable electronic apparatus according to the application example, it is preferable that, in a case where it is determined that the user is in a state of not viewing the electrophoretic panel on the basis of the body motion signal, the processing circuit performs the refreshing process.

According to this application example, for example, in a non-viewing state, or a state in which the user is supposed not to frequently view the wearable apparatus, the refreshing process can be performed. Consequently, it is possible to improve display quality without influencing display during viewing.

### APPLICATION EXAMPLE 17

A portable electronic apparatus according to this application example includes an electrophoretic panel; a storage unit that stores settlement information; a communication unit that communicates with a settlement terminal; and a processing circuit that is electrically connected to the electrophoretic panel, the storage unit, and the communication unit, in which, in a case where a settlement process is performed with the settlement terminal by using the settlement information, the processing circuit performs a refreshing process on the electrophoretic panel.

According to this application example, it is possible to efficiently and effectively perform a refreshing process on the electrophoretic panel at a meaningful timing such that the user does not suffer from stress. In other words, a refreshing process on the electrophoretic panel is not performed at a timing not intended by the user. Consequently, it is possible to improve display quality without influencing display during viewing. In a case where the processing circuit is configured to perform a refreshing process when a settlement process is performed with a settlement terminal by using settlement information, the refreshing process can suggest that the settlement process is being performed to the user, and thus the refreshing process can be performed at a meaningful timing.

### APPLICATION EXAMPLE 18

A control method for a portable electronic apparatus according to this application example includes an electrophoretic panel, the control method including detecting motion of a user, and outputting a body motion signal; receiving a communication signal from an external apparatus; and performing a refreshing process on the electrophoretic panel on the basis of either of the body motion signal and the communication signal.

According to this application example, it is possible to efficiently and effectively perform a refreshing process on the electrophoretic panel at a meaningful timing such that the user does not suffer from stress. In other words, a refreshing process on the electrophoretic panel is not performed at a timing not intended by the user. Consequently, it is possible to improve display quality without influencing display during viewing. In a case where the processing circuit is configured to perform a refreshing process on the basis of detection of either of a body motion signal and a communication signal, the refreshing process can suggest, for example, a determination result based on the body motion signal or reception of the communication signal to the user, and thus the refreshing process can be performed at a meaningful timing.

### APPLICATION EXAMPLE 19

A program executed by a portable electronic apparatus according to this application example including an electrophoretic panel, the program causing the portable electronic apparatus to execute detecting motion of a user, and outputting a body motion signal; receiving a communication signal from an external apparatus; and performing a refreshing process on the electrophoretic panel on the basis of either of the body motion signal and the communication signal.

According to this application example, it is possible to efficiently and effectively perform a refreshing process on the electrophoretic panel at a meaningful timing such that the user does not suffer from stress. In other words, a refreshing process on the electrophoretic panel is not performed at a timing not intended by the user. Consequently, it is possible to improve display quality without influencing display during viewing. In a case where the processing circuit is configured to perform a refreshing process on the basis of detection of either of a body motion signal and a communication signal, the refreshing process can suggest, for example, a determination result based on the body motion signal or reception of the communication signal to the user, and thus the refreshing process can be performed at a meaningful timing.

### BRIEF DESCRIPTION OF THE DRAWINGS

Embodiments will be described with reference to the accompanying drawings, wherein like numbers reference like elements.

FIG. 1 is a diagram illustrating a configuration example of a portable electronic apparatus of the present embodiment.

FIG. 2 is a diagram illustrating a configuration example of a wristwatch type apparatus (wrist apparatus) as an example of a wearable apparatus.

FIG. 3 is a diagram illustrating a first example of a first state of an activity state.

FIG. 4 is a diagram illustrating a first example of a second state of an activity state.

FIG. 5 is a diagram illustrating a second example of a first state of an activity state.

FIG. 6 is a diagram illustrating a second example of a second state of an activity state.

FIG. 7 is a diagram illustrating a first example of a display process of the present embodiment.

FIG. 8 is a diagram illustrating a second example of a display process of the present embodiment.

FIG. 9 is a diagram illustrating a third example of a display process of the present embodiment.

FIG. 10 is a diagram illustrating a fourth example of a display process of the present embodiment.

FIG. 11 is a diagram illustrating a fifth example of a display process of the present embodiment.

FIG. 12 is a diagram illustrating a sixth example of a display process of the present embodiment.

FIG. 13 is a diagram illustrating a seventh example of a display process of the present embodiment.

FIG. 14 is a diagram illustrating an eighth example of a display process of the present embodiment.

FIG. 15 is a diagram illustrating a ninth example of a display process of the present embodiment.

FIG. 16 is a diagram illustrating a tenth example of a display process of the present embodiment.

FIG. 17 is a diagram illustrating an eleventh example of a display process of the present embodiment.

FIG. 18 is a diagram illustrating a twelfth example of a display process of the present embodiment.

FIG. 19 is a diagram illustrating a thirteenth example of a display process of the present embodiment.

FIG. 20 is a diagram illustrating a fourteenth example of a display process of the present embodiment.

FIG. 21 is a graph illustrating a frequency characteristic of acceleration measured in a workout state (second state).

FIG. 22 is a graph illustrating a frequency characteristic of acceleration measured in a daily life state (first state).

FIG. 23 is a graph for explaining a method of determining a non-viewing state and a viewing state in a workout state.

### DESCRIPTION OF EXEMPLARY EMBODIMENTS

Hereinafter, exemplary embodiments of the invention will be described in detail. The present embodiment described below is not intended to limit the scope of the appended claims, and all constituent elements described in the present embodiment cannot be said to be necessarily essential as solving means of the invention.

### 1. Configuration

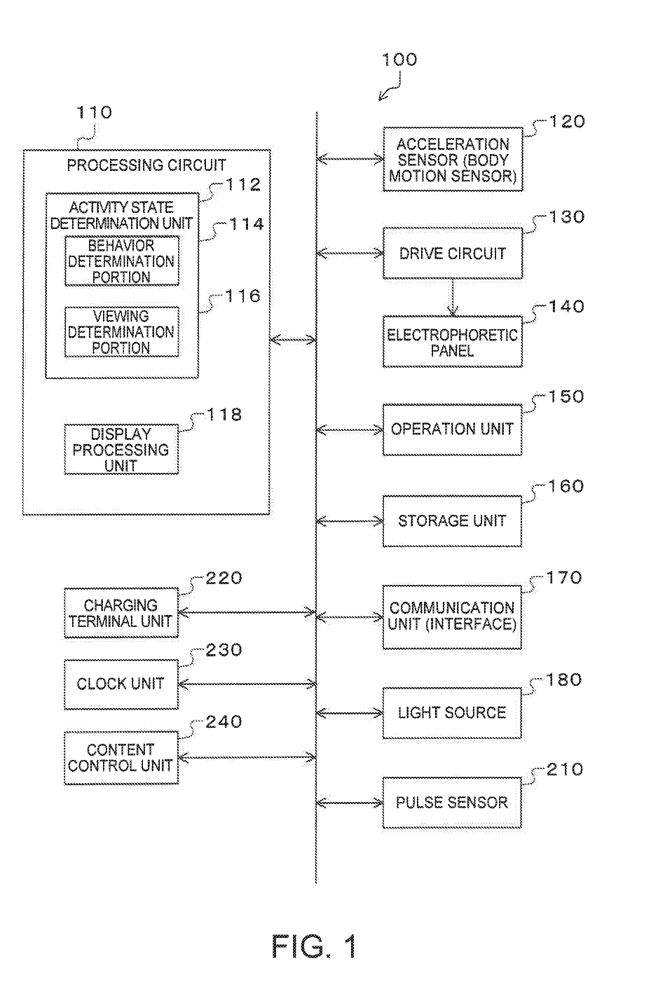

FIG. 1 is a diagram illustrating a configuration example of a wearable apparatus of the present embodiment.

A wearable apparatus 100 (portable electronic apparatus) according to the present embodiment includes a processing circuit 110 and an electrophoretic panel 140 (electrophoretic display). The wearable apparatus 100 may include an acceleration sensor 120 (body motion sensor), a drive circuit 130 (display driver), an operation unit 150 (operation device), a storage unit 160 (memory), a communication unit 170 (a communication circuit or an interface), and a light source 180 (illumination device). The wearable apparatus 100 may include a pulse sensor 210, a charging terminal unit 220, a clock unit 230, and a content control unit 240. The present embodiment is not limited to the configuration illustrated in FIG. 1, and may be variously modified by omitting some of the constituent elements or adding other constituent elements thereto.

The wearable apparatus 100 is an apparatus which can be worn by a user (mounted on any part of the body), and is an apparatus which presents information displayed on a display unit (the electrophoretic panel 140 in the present embodiment) to the user who views (visually recognizes) the display unit. Hereinafter, a case where the wearable apparatus 100 is mounted on the arm will be described as an example, but a mounting position is not limited to the arm. Hereinafter, a case where the wearable apparatus 100 displays time information or time measurement information (information measured through a stopwatch function) will be described as an example, but information displayed by the wearable apparatus 100 is not limited thereto. For example, the wearable apparatus 100 may be a biological information measurement apparatus (wearable health apparatus) such as a pulsimeter, a pedometer, or an activity meter.

The acceleration sensor 120 is a sensor measuring acceleration of the wearable apparatus 100. The acceleration sensor 120 detects motion of the user. The acceleration sensor 120 outputs a signal (body motion signal) corresponding to body motion. The acceleration sensor 120 measures acceleration (the magnitude thereof, or the magnitude and a direction thereof) generated due to motion of the wearable apparatus 100. Gravitational acceleration (direction thereof) may be measured. For example, an electrostatic capacitance type acceleration sensor which measures a change in electrostatic capacitance between an electrode of a movable portion and an electrode of a fixed portion as acceleration information, or a piezoelectric resistance type acceleration sensor which measures a resistance value of a piezoelectric element of when a weight attached to the piezoelectric element is displaced as acceleration information may be used. A body motion sensor (motion sensor) is not limited to the acceleration sensor, and any sensor may be used as long as the sensor can detect motion of the wearable apparatus 100. For example, a gyro sensor measuring angular velocity, an azimuth sensor measuring an azimuth, or a GNSS signal reception unit (GPS signal reception unit) acquiring orbit information or time information may be used. The GNSS signal reception unit receives an electric wave signal transmitted from an artificial satellite (navigation satellite) for satellite navigation. The GNSS signal reception unit receives a GNSS signal.

The pulse sensor 210 measures a pulse signal (pulse rate). The pulse sensor 210 includes a light emitting element such as a light emitting diode (LED) and a light receiving element such as a photodiode, and is provided at a portion in contact with the arm (skin) on a surface of the wearable apparatus 100 on the wrist side. Light is applied from the light emitting element toward the arm, the light receiving element receives light reflected at a blood vessel inside the arm, and then a pulse rate is measured by analyzing an amount of received light. The measured pulse rate is generally information useful to accurately determine whether the user is in a sleeping state or an awakening state. For example, a pulse rate of the user is normally measured, and, in a case where the pulse rate is equal to or less than a predetermined pulse rate value, it is determined that the user is in a sleeping state, and, in a case where the pulse rate is more than the predetermined pulse rate value, it is determined that the user is in an awakening state. The pulse sensor 210 is not an essential constituent element, and may be omitted, and sensors acquiring other biological information may be mounted.

The content control unit 240 (music reproduction unit) reproduces the content such as music or a moving image. The content control unit 240 is a functional unit reproducing content data including music data stored in the storage unit 160 or the like.

The clock unit 230 measures time. The clock unit 230 is a real time clock, and has clocking functions such as a timer function, a clock function, and a stopwatch function. A timer of the clock unit 230 is output to the processing circuit 110, and is used to generate a sampling time for detecting a sensor signal from the acceleration sensor 120 or the pulse sensor 210, the unit time for calculating an inclined angle, or the like.

The charging terminal unit 220 is connected to a charger (not illustrated). A battery (not illustrated) built into the wearable apparatus 100 is connected to the charger via the charging terminal unit 220, and is charged or discharged.

The electrophoretic panel 140 is a reflective display panel using an electrophoretic method. In the electrophoretic method, a cell is provided between a first electrode (a light transmissive electrode or a pixel electrode) and a second electrode (counter electrode), dispersion media (media) and charged particles fill the cell, and the charged particles are moved by applying a voltage between the electrodes. For example, in a case where the charged particles include white particles having positive electric charge and black particles having negative electric charge, if the first electrode side is subjected to a positive voltage relative to the second electrode, the black particles are moved to the first electrode side such that black display is realized, and, if the first electrode side is subjected to a negative voltage relative to the second electrode, the white particles are moved to the first electrode side such that white display is realized. Various specific configurations of the electrophoretic panel 140 may be supposed, and there is, for example, a capsule type electrophoretic panel in which a capsule filled with dispersion media and charged particles is disposed between electrodes, or a partition wall type electrophoretic panel including an electrophoretic layer which is provided between a first substrate and a second substrate disposed to oppose each other and has dispersion media (containing charged particles) partitioned into a plurality of cells by partition walls.

The drive circuit 130 is a circuit which outputs a drive signal (a drive voltage waveform or a drive voltage pattern) for driving the electrophoretic panel 140. In other words, a drive signal corresponding to a grayscale to be displayed by a pixel is output to an electrode of each pixel of the electrophoretic panel 140, and thus an image is displayed on the electrophoretic panel 140. The drive circuit 130 is configured to select a partial region of the electrophoretic panel 140 and to drive only pixels of the region. For example, writing (display update) is performed on only an updated region from a previously written image. The drive circuit 130 is implemented by, for example, an integrated circuit device.

The operation unit 150 is a device for the user to operate the wearable apparatus 100. The operation unit 150 is an input device configured to include button switches and the like, and outputs a signal corresponding to a pressed button to the processing circuit. The operation unit 150 is not limited to such a configuration, and may have a configuration in which a plurality of input operations are allowed, and, for example, the electrophoretic panel 140 may have a touch panel function. The operation unit 150 receives an operation of the user. The operation unit 150 outputs an operation signal.

The storage unit 160 is, for example, a RAM or a nonvolatile memory. For example, the storage unit 160 functions as a work memory of the processing circuit 110, a memory which temporarily stores various pieces of data (for example, acceleration data acquired by the acceleration sensor 120, or measured biological information data in a case of a biological information measurement apparatus), or a memory storing setting information of the wearable apparatus 100. The storage unit 160 stores settlement information.

The communication unit 170 is a circuit performing communication between the wearable apparatus 100 and an external apparatus (for example, an information processing apparatus, a portable information processing terminal, or a settlement terminal) (not illustrated). For example, setting information is transmitted to the wearable apparatus 100 from the external apparatus via the communication unit 170. Alternatively, various pieces of data (for example, in a case of a biological information measurement apparatus, measured biological information data) are transmitted to the external apparatus from the wearable apparatus 100 via the communication unit 170. The communication unit 170 receives a communication signal from the external apparatus. The communication signal may include at least one of reception of a call, reception of an electronic message, a notification of a schedule associated with calendar setting, and reception of music data.

The light source 180 is a light source generating illumination light for illuminating the electrophoretic panel 140. The electrophoretic panel 140 is reflective, and thus illumination light is applied from a display surface (a side on which a transparent electrode is disposed) of the electrophoretic panel 140.

The processing circuit 110 performs, for example, a data process of processing various pieces of data, a control process of controlling the wearable apparatus 100, and a display process of displaying an image on the electrophoretic panel 140. The processing circuit 110 is electrically connected to the electrophoretic panel 140, the acceleration sensor 120, and the communication unit 170. The processing circuit 110 is, for example, a processor, and the processor includes at least one of a circuit processing a digital signal and a circuit processing an analog signal. For example, the processor is implemented by, for example, a micro processing unit (MPU), a central processing unit (CPU), or a digital signal processor (DSP). In this case, a program (a command or software) on which functions of the processing circuit 110 are described is stored in the storage unit 160 (for example, a ROM or a nonvolatile memory), and the processing circuit 110 reads and executes the program such that the functions of the processing circuit 110 are realized. Alternatively, the processor may be implemented by dedicated hardware such as an application specific integrated circuit (ASIC).

As illustrated in FIG. 1, the processing circuit 110 includes an activity state determination unit 112 and a display processing unit 118. In a case where the processing circuit 110 is an MPU or the like, for example, each unit is realized by a program module.

The activity state determination unit 112 acquires (measures) information regarding at least one of motion and an attitude of the wearable apparatus 100 on the basis of acceleration measured by the acceleration sensor 120, and determines a state of the wearable apparatus 100 on the basis of the information. Specifically, an activity state of the user wearing the wearable apparatus 100 is determined. The activity state determination unit 112 performs a behavior determination of determining how a certain behavior of the user is performed and a use state determination of determining whether or not the wearable apparatus 100 is used by the user in a predetermined use state. Specifically, the activity state determination unit 112 includes a behavior determination portion 114 which performs the behavior determination, and a viewing determination portion 116 (use state determination portion) which performs the use state determination.

Hereinafter, for better understanding of the technical spirit of the present application, a description will be made of a case of determining running (or walking) or a daily life state (non-workout state) as an example of the behavior determination, but the behavior determination is not limited thereto. For example, a workout state of performing any sport and a non-workout state may be determined, and an awakening state and a sleeping state may be determined. Hereinafter, a description will be made of a case of determining a viewing state in which the user holds the electrophoretic panel 140 in a direction in which the electrophoretic panel 140 can be viewed as an example of the use state determination, but the use state determination is not limited thereto. For example, whether or not the user wears the wearable apparatus 100 may be determined.

The display processing unit 118 performs a display process (display control) of controlling the drive circuit 130 to display an image on the electrophoretic panel 140. For example, the display processing unit 118 transmits display data to the drive circuit 130, and the drive circuit 130 generates a drive voltage waveform corresponding to the display data so as to drive the electrophoretic panel 140. Alternatively, the display processing unit 118 generates a drive voltage waveform corresponding to display data, and outputs the drive voltage waveform to the drive circuit 130, and the drive circuit 130 amplifies the drive voltage waveform so as to drive the electrophoretic panel 140. The display processing unit 118 controls the display content (the display content, for example, year, month, and day, hour and minute, time measurement information, and biological information) to be displayed on the electrophoretic panel 140. The display processing unit 118 sets (controls) a display region on which writing of an image (display update or driving of a pixel) is performed on the basis of the display content. The display processing unit 118 performs a process of writing white or black into all pixels of the electrophoretic panel 140 at a predetermined timing (for example, the time at which a power source of the wearable apparatus 100 is turned off, or the time at which an operation of the drive circuit 130 is turned off), or a process of writing a predetermined still image. The display processing unit 118 performs a process of refreshing the electrophoretic panel 140 at a predetermined timing (for example, whenever display is updated a predetermined number of times or the time at which the user is brought into a predetermined activity state). The display processing unit 118 performs a refreshing process on refreshing the electrophoretic panel 140 on the basis of either of a body motion signal and a communication signal. Here, the refreshing process indicates a process of performing monochrome display (full-screen black display or full-screen white display) by applying a predetermined voltage between a pair of electrodes in order to remove aggregation or biasing of charged particles of the electrophoretic panel 140. In other words, a screen display process in which a predetermined screen is displayed via monochrome display such as white or black is referred to as a refreshing process.

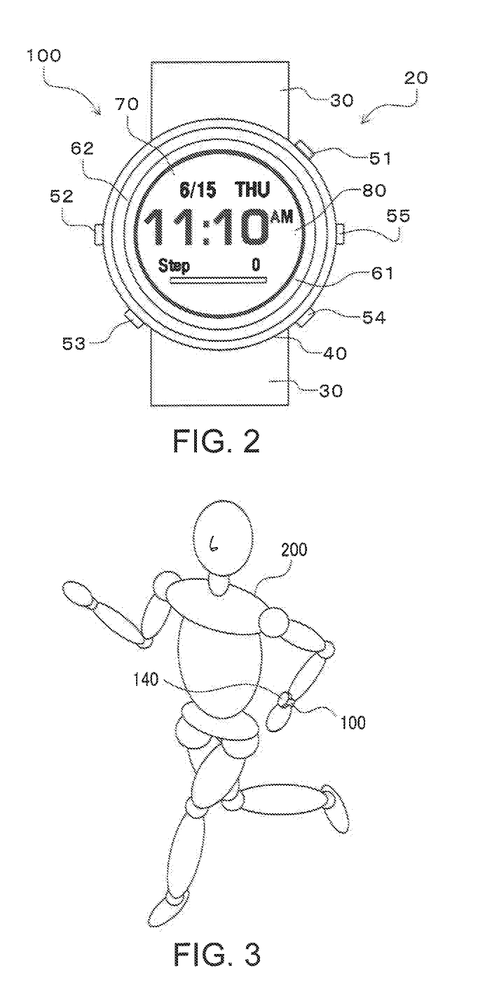

FIG. 2 illustrates a configuration example of a wristwatch type apparatus (wrist apparatus) as an example of the wearable apparatus 100. The wearable apparatus 100 is not limited to a wristwatch type, and may be an apparatus mounted on a predetermined part of the body.

FIG. 2 illustrates the wearable apparatus 100 viewed in a plan view of a display surface of the electrophoretic panel 140. The wearable apparatus 100 includes an apparatus main body 20, and a band 30 (mounting tool) for mounting the apparatus main body 20 on the user's wrist (a predetermined part of the body).

The apparatus main body 20 has a case 40 in which an opening is provided on an opposite side (front side) to a side (rear side) mounted on the user. A bezel 62 is provided outside the opening of the case 40, and a windshield plate 70 (for example, a glass plate) is provided to cover the opening of the case 40 inside the bezel 62. Operation buttons 51 to 55 are provided on a side surface of the case. The operation buttons 51 to 55 correspond to the operation unit 150 illustrated in FIG. 1, and an operation mode, the display content, or the like of the wearable apparatus 100 may be set by operating the operation buttons 51 to 55. An electrophoretic panel 80 is provided under the windshield plate 70 (inside the case 40) such that the display surface faces the windshield plate 70. The electrophoretic panel 80 corresponds to the electrophoretic panel 140 illustrated in FIG. 1. A parting plate 61 (ring-shaped plate) is provided between the windshield plate 70 and the electrophoretic panel 140 at an outer edge of the windshield plate 70. The electrophoretic panel 140 can be visually recognized via an opening of the parting plate 61.

The processing circuit 110 (display processing unit 118) in FIG. 1 performs a display process of the present embodiment at least a region which can be visually recognized from the parting plate 61 in the display surface of the electrophoretic panel 140. The display process of the present embodiment may be performed on the entire display surface including regions other than the region which can be visually recognized from the parting plate 61.

### 2. Operation

As described above, the wearable apparatus 100 of the present embodiment uses the electrophoretic panel 140 as a display panel. The electrophoretic panel has an advantage that an angle of view at which visual recognition is possible is wider than a liquid crystal display panel, and visibility is high even in a bright location (outdoors or under the sunlight) since the electrophoretic panel is reflective. In the electrophoretic panel, if a grayscale is written into a pixel, the written grayscale is maintained, and, thus, power consumption is low in a case where the same image is continuously displayed.

However, information presented to a user by the wearable apparatus 100 includes information (for example, the second digit of time, the second digit of time measurement (stopwatch function), a pulse rate, the number of steps, and the like) of which an update frequency is relatively high. Since the wearable apparatus 100 typically uses a battery or a cell as a power source, low power consumption is preferable, and power consumption due to driving of the electrophoretic panel is preferably reduced. Thus, display update (driving of pixels) may be performed on only a display region in which an image is updated. However, since the electrophoretic panel has a characteristic in which the electrophoretic panel deteriorates as the number of times of display update increases, if a partial display region is subjected to frequent display update, a difference occurs in the extent of deterioration between the region and other regions. For example, display contrast lowers over time due to degradation of motion of a charged particle in a medium, or a change in a response to a drive signal caused by a change in electric charge of a charged particle. In a case where such deterioration occurs, a color of a display region subjected to frequent display update may be seen to be different (seen gray) from a color of other display regions.

Therefore, the wearable apparatus 100 of the present embodiment includes the electrophoretic panel 140, and the acceleration sensor 120 (body motion sensor) which detects motion of a user and outputs a body motion signal, the communication unit 170 which receives a communication signal from an external apparatus (not illustrated), and the processing circuit 110 electrically connected to the electrophoretic panel 140, the acceleration sensor 120, and the communication unit 170, and performs a refreshing process on the electrophoretic panel 140 on the basis of either of the body motion signal and the communication signal.

The refreshing process is a process of returning (refreshing or initializing) a position of a particle in a cell of the electrophoretic panel 140 to a predetermined position, and is realized, for example, by applying a predetermined drive voltage waveform (for example, alternating writing of black and white) to a pixel of the electrophoretic panel 140.

In the electrophoretic panel 140, when a certain grayscale written into a pixel, an actually written grayscale may change (have an error) depending on a previously written grayscale of the pixel. Thus, in a display region in which update of second display or the like is repeatedly performed, contrast may be reduced, or a ghost may occur. According to the present embodiment, a refreshing process can be performed in a non-viewing state (or a daily life state in which the wearable apparatus is supposed not to be frequently viewed), and thus display quality can be improved without influencing display during viewing.

States of the user and the wearable apparatus 100 when an activity state is determined are, for example, a state in which the user wears the wearable apparatus 100. The states are not limited thereto, and may be a state in which body motion of the user is transmitted to the wearable apparatus 100. For example, the states may be a state in which the user carries the wearable apparatus 100.

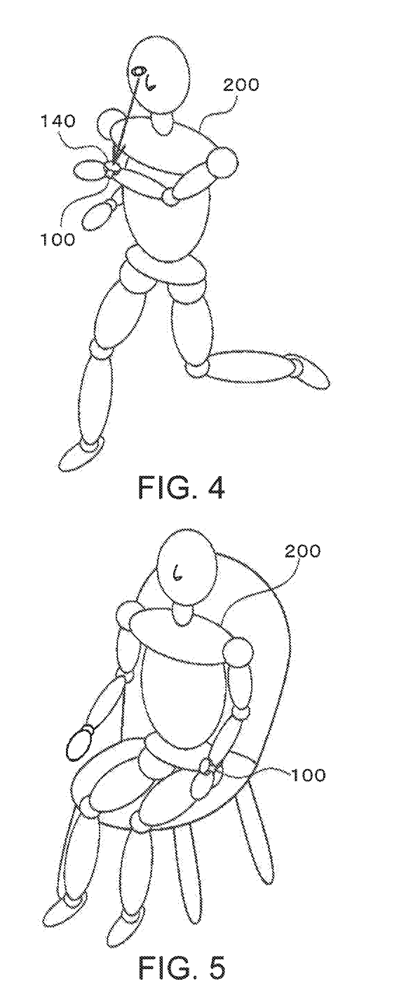

FIG. 3 illustrates a first example of a first state of the activity state. FIG. 4 illustrates a first example of a second state of the activity state. In these examples, the wearable apparatus 100 is a wristwatch type apparatus, and is mounted on the left wrist of a user 200. The first state (FIG. 3) is a state in which the user 200 performs running or walking, and the user 200 naturally swings the arms. In other words, the first state is a state in which a direction of the display surface of the electrophoretic panel 140 changes in accordance with motion of the arms, and the user 200 does not view the display surface. On the other hand, the second state (FIG. 4) is a state in which the user 200 performs running or walking, but the user 200 maintains the arm at a position where the display surface of the electrophoretic panel 140 can be viewed.

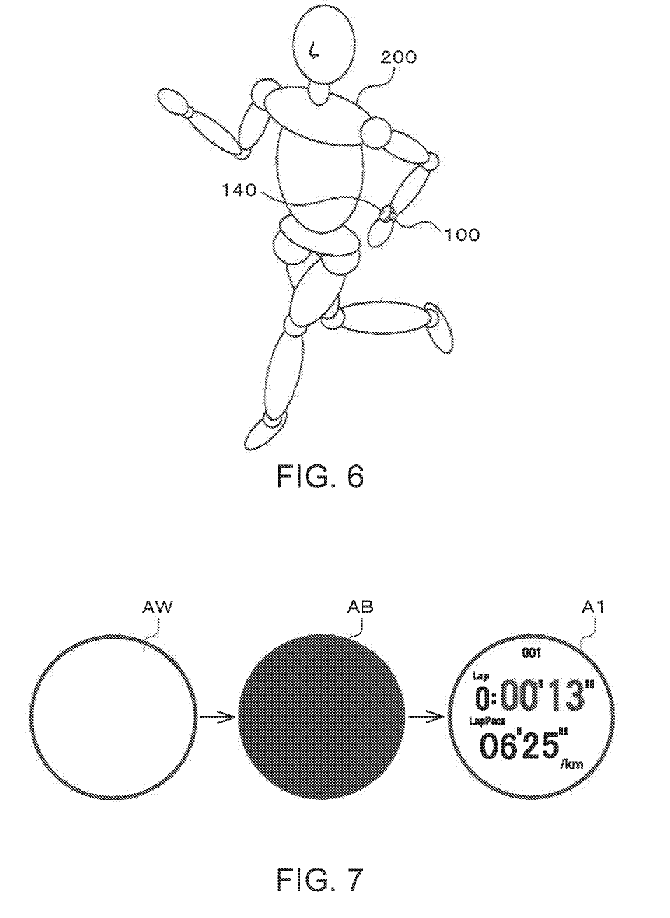

FIG. 5 illustrates a second example of a first state of the activity state. FIG. 6 illustrates a second example of a second state of the activity state. In these examples, the wearable apparatus 100 is a wristwatch type apparatus, and is mounted on the left wrist of a user 200. The first state is a daily life state (non-workout state) of the user 200. In other words, the first state is a state in which the user 200 does not perform an activity with great workout intensity, and performs an activity with relatively small workout intensity (for example, an average value of acceleration measured by the acceleration sensor is small). On the other hand, the second state is a state in which the user 200 is performing a workout. In other words, the second state is a state in which the user 200 performs an activity with relatively great workout intensity (for example, an average value of acceleration measured by the acceleration sensor is great). FIG. 6 illustrates a state in which the user 200 performs running or walking, but this is only an example, and there may be an activity with workout intensity larger than in the first state. For example, the first state may be a sleeping state, and the second state may be a daily life state (awakening state).

The activity state determination unit 112 of the processing circuit 110 determines whether or not an activity state is the first state and whether or not an activity state is the second state on the basis of a measurement result in the acceleration sensor 120 (body motion sensor). For example, in the examples illustrated in FIGS. 3 and 4, the viewing determination portion 116 of the activity state determination unit 112 determines a viewing state or a non-viewing state. In the examples illustrated in FIGS. 5 and 6, the behavior determination portion 114 of the activity state determination unit 112 determines a daily life state or a workout state. Details of a determination method will be described later.

In the examples illustrated in FIGS. 3 and 4, the first state is a state in which the user 200 does not view the wearable apparatus 100, and, thus, fundamentally, information may be displayed on the electrophoretic panel 140 in the second state (viewing state).

FIGS. 7 to 20 illustrate first to fourteenth examples of a display process of the present embodiment.

More specifically, in a case where the processing circuit 110 determines a separation position of a lap time (lap) on the basis of a body motion signal from the acceleration sensor 120, a refreshing process may be performed. The electrophoretic panel 140 may display lap time information corresponding to the separation position of the lap time after the refreshing process is performed.

For example, in the example illustrated in FIG. 7, in a case where a separation position of a lap time (lap) is determined on the basis of a body motion signal from the acceleration sensor 120, the electrophoretic panel 140 performs white display indicated by AW and black display indicated by AB on the entire screen a predetermined number of times, and then performs display update to a screen including lap time information indicated by A1. Alternatively, in a case where a separation position of a lap time (lap) is determined on the basis of a body motion signal from the acceleration sensor 120, the electrophoretic panel 140 performs a refreshing process on the entire screen, and then performs display update to a screen including lap time information indicated by A1. According thereto, for example, in a non-viewing state, or a state in which the user is supposed not to frequently view the wearable apparatus, the refreshing process can be performed. Consequently, it is possible to improve display quality without influencing display during viewing. A movement distance is measured on the basis of a body motion signal, and, in a case where the movement distance exceeds a preset predetermined distance, for example, 1 km, the refreshing process can be performed. Consequently, the refreshing process can indicate a lap section end, and thus the refreshing process can be performed at a meaningful timing.

In the present embodiment, in a case where the communication unit 170 receives a communication signal, the processing circuit 110 may perform the refreshing process. The electrophoretic panel 140 may display notification information corresponding to the received communication signal after the refreshing process is performed.

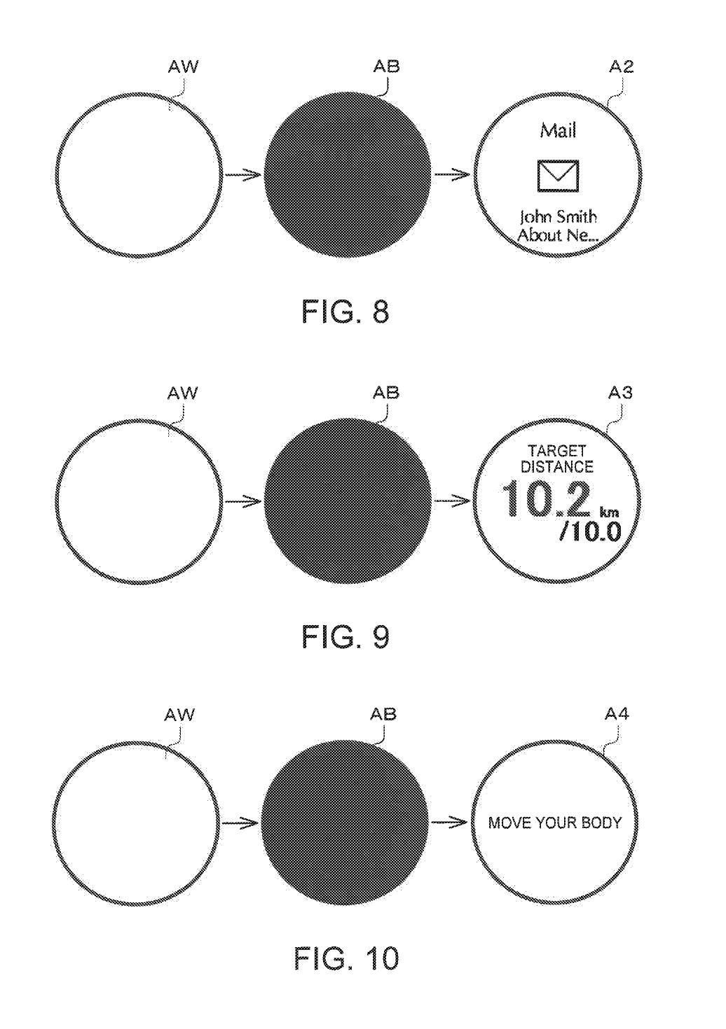

For example, in the example illustrated in FIG. 8, in a case where the communication unit 170 receives a communication signal, the electrophoretic panel 140 performs white display indicated by AW and black display indicated by AB on the entire screen a predetermined number of times, and then performs display update to a screen including mail information indicated by A2. Alternatively, in a case where the communication unit 170 receives a communication signal, the electrophoretic panel 140 performs a refreshing process on the entire screen, and then performs display update to a screen including mail information indicated by A2. According thereto, for example, in a non-viewing state, or a state in which the user is supposed not to frequently view the wearable apparatus, the refreshing process can be performed. Consequently, it is possible to improve display quality without influencing display during viewing. The refreshing process is performed when a reception signal regarding at least one of reception of a call, reception of an electronic message, a notification of a schedule, and reception of music data is received, and thus the refreshing process can indicate notifying the user of reception of information, so that the refreshing process can be performed at a meaningful timing.

In the present embodiment, in a case where it is determined that values of various workout indexes which are indexes regarding workouts performed by the user 200 have achieved preset target information on the basis of the body motion signal, the processing circuit 110 may perform a refreshing process. The electrophoretic panel 140 may display information indicating target achievement after the refreshing process is performed.

For example, in the example illustrated in FIG. 9, in a case where it is determined that values of workout indexes which are indexes regarding workout capability of the user 200 have achieved preset target information, the electrophoretic panel 140 performs white display indicated by AW and black display indicated by AB on the entire screen a predetermined number of times, and then performs display update to a screen including target distance information indicated by A3. Alternatively, in a case where the communication unit 170 receives a communication signal, the electrophoretic panel 140 performs a refreshing process on the entire screen, and then performs display update to a screen including target distance information indicated by A3.

For example, in a case where a measurement starting command is received, the wearable apparatus 100 starts measurement using the acceleration sensor 120, calculates values of various workout indexes which are indexes regarding running capability (an example of workout capability) of the user 200 by using a measurement result, and generates workout analysis information including the values of the various workout indexes as information regarding an analysis result of the running workout of the user 200. The wearable apparatus 100 compares the values of the various workout indexes with, for example, respective target values set in advance, and mainly notifies the user 200 of whether or not the various workout indexes are favorable in sounds or vibration. Consequently, the user 200 can perform running while recognizing whether or not the workout indexes are favorable.

The various workout indexes calculated in the wearable apparatus 100 are not particularly limited, but may include, for example, a brake amount in landing (a workout indexes defined as a speed amount reduced due to landing), a directly-below landing ratio (a workout index expressing whether or not landing is performed directly below the body), propulsion force (a workout indexes defined as a speed amount increased in an advancing direction by kicking the ground), a forward tilt angle (a workout indexes indicating to what extent the body of the user 200 is tilted forward with respect to the ground), and the slow turnover (a workout indexes indicating to what extent a leg remains behind at the next landing point of the kicking leg). According thereto, for example, in a non-viewing state, or a state in which the user is supposed not to frequently view the wearable apparatus, the refreshing process can be performed. Consequently, it is possible to improve display quality without influencing display during viewing.

The refreshing process is performed when target information regarding a workout performed by the user 200 is achieved, for example, when the user 200 sets a target such as “8000 steps a day”, and the number of accumulated steps calculated on the basis of a body motion signal exceeds the target value, the refreshing process may be configured to be performed. Consequently, the refreshing process can indicate achievement of a target, and thus the refreshing process can be performed at a meaningful timing.

In the present embodiment, in a case where it is determined that the wearable apparatus 100 transitions to a movement state from a standing still state on the basis of a body motion signal from the acceleration sensor 120 illustrated in FIG. 1, the processing circuit 110 may perform a refreshing process. According thereto, for example, in a non-viewing state, or a state in which the user is supposed not to frequently view the wearable apparatus, the refreshing process can be performed. Consequently, it is possible to improve display quality without influencing display during viewing. The refreshing process is performed when it is determined that the wearable apparatus 100 transitions to a movement state from a standing still state on the basis of the body motion signal, for example, when the wearable apparatus 100 placed on a table is raised by the user, and thus the user 200 can recognize that the wearable apparatus 100 normally functions even if a screen of the wearable apparatus 100 disappears in a sleep state, or is in a state in which the past screen is still displayed.

In the present embodiment, in a case where it is determined that the wearable apparatus 100 is detached from the body of the user 200 on the basis of a body motion signal from the acceleration sensor 120 illustrated in FIG. 1, the processing circuit 110 may perform a refreshing process. According thereto, for example, in a non-viewing state, or a state in which the user is supposed not to frequently view the wearable apparatus, the refreshing process can be performed. Consequently, it is possible to improve display quality without influencing display during viewing. The refreshing process is performed when it is determined that the wearable apparatus 100 is detached from the body of the user 200 on the basis of a body motion signal, it is possible to suggest that the wearable apparatus 100 has recognized a change in a mounting state to the user 200.

In the present embodiment, in a case where a change in a behavior type of the user 200 is detected on the basis of a body motion signal from the acceleration sensor 120, the processing circuit 110 may perform a refreshing process. Here, the change in a behavior type is, for example, a change between a sleeping state and an awakening state, or a change between a sitting state and a standing state.

For example, in the example illustrated in FIG. 10, in a case where it is determined that the user 200 continuously sits over a predetermined period on the basis of a body motion signal from the acceleration sensor 120, the electrophoretic panel 140 performs white display indicated by AW and black display indicated by AB on the entire screen a predetermined number of times, and then performs display update to a screen including information for prompting the user to move the body thereof indicated by A4. Alternatively, in a case where a separation position of a lap time (lap) is determined on the basis of a body motion signal from the acceleration sensor 120, the electrophoretic panel 140 performs a refreshing process on the entire screen, and then performs display update to a screen including information for prompting the user to move the body thereof indicated by A4. According thereto, for example, in a non-viewing state, or a state in which the user is supposed not to frequently view the wearable apparatus, the refreshing process can be performed. Consequently, it is possible to improve display quality without influencing display during viewing. The refreshing process is performed when a change in a behavior type of the user 200 is detected on the basis of the body motion signal, and thus it is possible to suggest that the wearable apparatus 100 has recognized the change in a behavior type of the user 200 to the user 200.

In the present embodiment, in a case where measurement using a GNSS signal from a GNSS signal reception unit (not illustrated) is possible, the processing circuit 110 may perform a refreshing process. The electrophoretic panel 140 may display a measurement screen corresponding to the received GNSS signal after the refreshing process is performed.

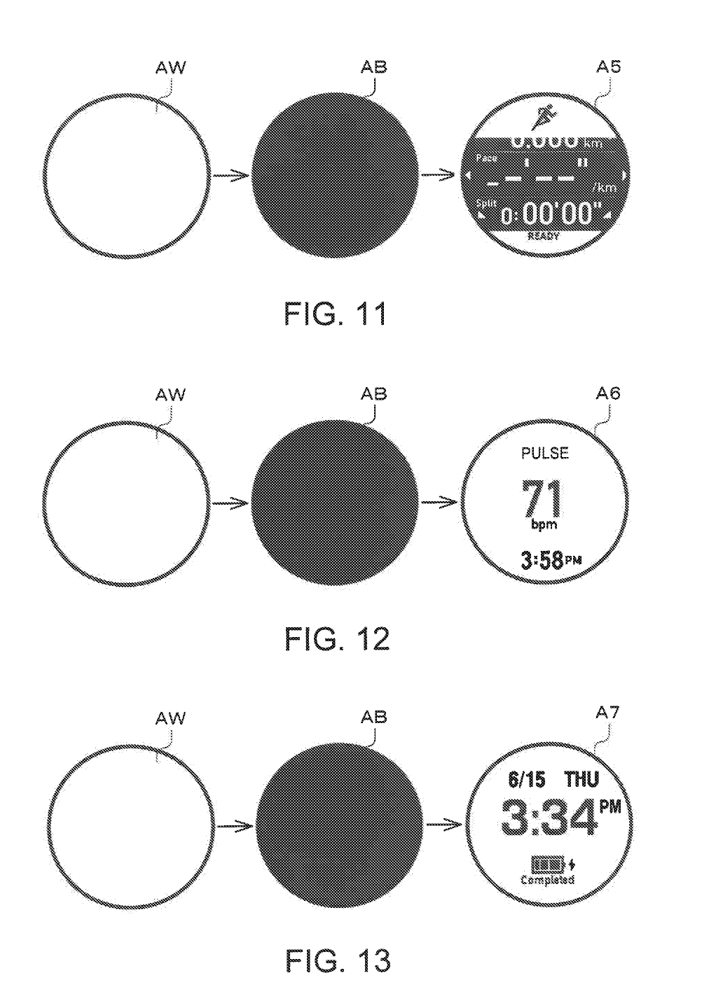

For example, in the example illustrated in FIG. 11, in a case where measurement using a GPS signal from a GPS signal reception unit (not illustrated) is possible, the electrophoretic panel 140 performs white display indicated by AW and black display indicated by AB on the entire screen a predetermined number of times, and then performs display update to a screen including GPS positioning progress information indicated by A5. Alternatively, in a case where measurement using a GPS signal from a GPS signal reception unit (not illustrated) is possible, the electrophoretic panel 140 performs a refreshing process on the entire screen, and then performs display update to a screen including GPS positioning progress information indicated by A5. According thereto, for example, in a non-viewing state, or a state in which the user is supposed not to frequently view the wearable apparatus, the refreshing process can be performed. Consequently, it is possible to improve display quality without influencing display during viewing. In a case where a refreshing process is configured to be performed when measurement using a GPS signal is possible, the refreshing process can indicate notifying the user 200 of a state of being capable of performing position measurement, and thus the refreshing process can be performed at a meaningful timing.

In the present embodiment, in a case where measurement of a pulse signal in the pulse sensor 210 is possible, the processing circuit 110 may perform a refreshing process. The electrophoretic panel 140 may display an icon indicating that measurement of a pulse is in progress after the refreshing process is performed.

For example, in the example illustrated in FIG. 12, in a case where measurement of a pulse signal in the pulse sensor 210 is possible, the electrophoretic panel 140 performs white display indicated by AW and black display indicated by AB on the entire screen a predetermined number of times, and then performs display update to a screen including pulse rate information indicated by A6. Alternatively, in a case where measurement of a pulse signal in the pulse sensor 210 is possible, the electrophoretic panel 140 performs a refreshing process on the entire screen, and then performs display update to a screen including pulse rate information indicated by A6. According thereto, for example, in a non-viewing state, or a state in which the user is supposed not to frequently view the wearable apparatus, the refreshing process can be performed. Consequently, it is possible to improve display quality without influencing display during viewing. In a case where a refreshing process is configured to be performed when measurement of a pulse signal in the pulse sensor 210 is possible, the refreshing process can indicate notifying the user 200 of a state of being capable of performing pulse measurement, and thus the refreshing process can be performed at a meaningful timing.

In the present embodiment, in a case where it is determined that connection between the charging terminal unit 220 and the charger (not illustrated) is canceled, the processing circuit 110 may perform a refreshing process. The processing circuit 110 may perform the refreshing process when charging using the charger is completed.

For example, in the example illustrated in FIG. 13, in a case where it is determined that the charging terminal unit 220 is disconnected from the charger (not illustrated), the electrophoretic panel 140 performs white display indicated by AW and black display indicated by AB on the entire screen a predetermined number of times, and then performs display update to a screen including charging completion information indicated by A7. Alternatively, in a case where it is determined that the charging terminal unit 220 is disconnected from the charger (not illustrated), the electrophoretic panel 140 performs a refreshing process on the entire screen, and then performs display update to a screen including charging completion information indicated by A7. According thereto, for example, in a non-viewing state, or a state in which the user is supposed not to frequently view the wearable apparatus, the refreshing process can be performed. Consequently, it is possible to improve display quality without influencing display during viewing. In a case where a refreshing process is configured to be performed when the disconnection from the charger is determined, the refreshing process can indicate notifying the user 200 of ending of a charging operation, and thus the refreshing process can be performed at a meaningful timing. The refreshing process may be performed on the hour, at the time of starting charging, at the time of completing charging, or at the time of being attached to or detached from a cradle in a charging mode (during charging). A watch screen (default screen) may be displayed after the refreshing process is performed.

In the present embodiment, in a case where a time point from the clock unit 230 is the hour (e.g., a time measured from the clock unit 230 increases by an hour), or a split time is the hour (e.g., a split time measured from the clock unit 230 increases by an hour), the processing circuit 110 may perform a refreshing process.

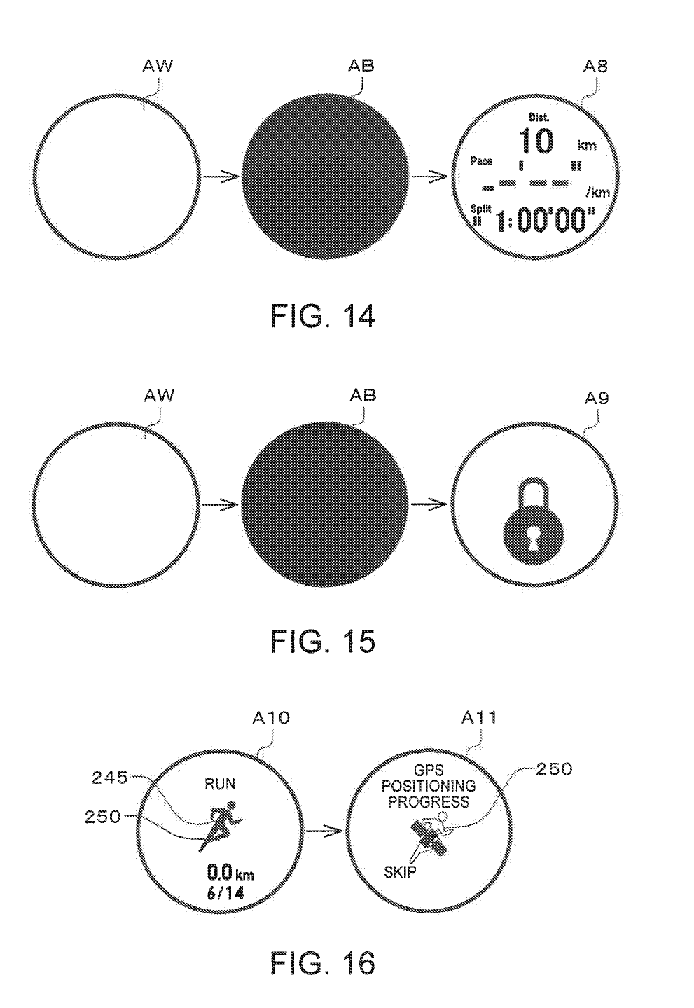

For example, in the example illustrated in FIG. 14, in a case where a time point from the clock unit 230 is the hour, or a split time is the hour, the electrophoretic panel 140 performs white display indicated by AW and black display indicated by AB on the entire screen a predetermined number of times, and then performs display update to a screen including the hour information of a split time indicated by A8. Alternatively, in a case where a time point from the clock unit 230 is the hour, or a split time is the hour, the electrophoretic panel 140 performs a refreshing process on the entire screen, and then performs display update to a screen including the hour information of a split time indicated by A8. According thereto, for example, in a non-viewing state, or a state in which the user is supposed not to frequently view the wearable apparatus, the refreshing process can be performed. Consequently, it is possible to improve display quality without influencing display during viewing. In a case where a refreshing process is configured to be performed when a time point from the clock unit 230 is the hour, or a split time is the hour, the refreshing process can indicate notifying the user 200 of a time point or separation of an elapsed time, and thus the refreshing process can be performed at a meaningful timing. The refreshing process may be performed at each timing of exiting from a watch screen, of returning to a watch screen, of exiting from a measurement screen, and of returning to a measurement screen.

In the present embodiment, in a case where an operation signal from the operation unit 150 illustrated in FIG. 1 is detected, the processing circuit 110 may perform a refreshing process. According thereto, for example, in a non-viewing state, or a state in which the user is supposed not to frequently view the wearable apparatus, the refreshing process can be performed. Consequently, it is possible to improve display quality without influencing display during viewing. In a case where the processing circuit 110 is configured to perform a refreshing process when an operation signal from the operation unit 150 is detected, the refreshing process can suggest that the processing circuit 110 has detected the operation signal to the user 200, and thus the refreshing process can be performed at a meaningful timing.

In the present embodiment, in a case where an operation signal corresponding to at least one of a menu screen transition operation and a lock function ON/OFF operation is detected, the processing circuit 110 may perform a refreshing process.

For example, in the example illustrated in FIG. 15, in a case where an operation signal corresponding to at least one of a menu screen transition operation and a lock function ON/OFF operation is detected, the electrophoretic panel 140 performs white display indicated by AW and black display indicated by AB on the entire screen a predetermined number of times, and then performs display update to a screen including lock function ON information indicated by A9. Alternatively, in a case where an operation signal corresponding to at least one of a menu screen transition operation and a lock function ON/OFF operation is detected, the electrophoretic panel 140 performs a refreshing process on the entire screen, and then performs display update to a screen including lock function ON information indicated by A9. According thereto, it is possible to perform the refreshing process in a state in which at least one of a menu screen transition operation and a lock function ON/OFF operation is included. Consequently, it is possible to improve display quality without influencing display during viewing. In a case where the processing circuit 110 is configured to perform a refreshing process when an operation signal corresponding to at least one of a menu screen transition operation and a lock function ON/OFF operation is detected, the refreshing process can suggest that the processing circuit 110 has detected the operation signal to the user 200, and thus the refreshing process can be performed at a meaningful timing. For example, a refreshing process may be performed through button operations during transition among ready, start, and pause.

In the present embodiment, when display of the electrophoretic panel 140 is switched from a first screen to a second screen, the electrophoretic panel 140 may leave at least a partial outline of an object included in the first screen, and may display the outline and the second screen. Here, the object may include, for example, text, a figure, a picture, a photograph, and a symbol displayed on a screen.

For example, in the example illustrated in FIG. 16, when a first screen indicated by A10 is switched to a second screen indicated by A11, the electrophoretic panel 140 leaves at least a partial outline 250 of a human form (object) 245 included in the first screen A10, and displays the outline 250 and the second screen A11 not including the outline 250. According thereto, a refreshing process timing and an area for performing screen switching can be reduced, and thus it is possible to reduce power consumption due to the refreshing process.

In the present embodiment, in a case where the content control unit 240 detects a change from the first content to the second content, the processing circuit 110 may perform a refreshing process. Here, the content may include, for example, music, a moving image, and a text message.

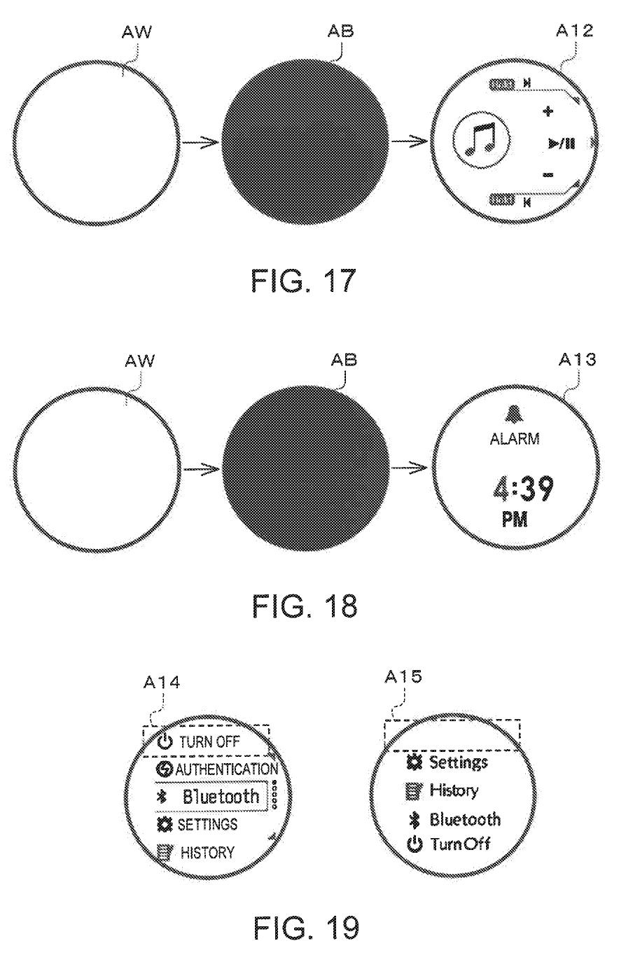

For example, in the example illustrated in FIG. 17, in a case where the processing circuit 110 determines a state in which the content control unit 240 reproduces music, the electrophoretic panel 140 performs white display indicated by AW and black display indicated by AB on the entire screen a predetermined number of times, and then performs display update to a screen including music reproduction information indicated by A12. Alternatively, in a case where a state in which the content control unit 240 reproduces music is determined, the electrophoretic panel 140 performs a refreshing process on the entire screen, and then performs display update to a screen including music reproduction information indicated by A12. According thereto, for example, in a non-viewing state, or a state in which the user is supposed not to frequently view the wearable apparatus, the refreshing process can be performed. Consequently, it is possible to improve display quality without influencing display during viewing. In a case where the processing circuit 110 is configured to perform a refreshing process when the content control unit 240 detects a change from the first content to the second content, the refreshing process can suggest that the content such as a piece of music has been changed to the user 200, and thus the refreshing process can be performed at a meaningful timing.

In the present embodiment, in a case of a selection operation on a menu screen performed by the user 200, the processing circuit 110 may not perform a refreshing process. According thereto, the refreshing process is not performed, and thus information required in a selection operation on a menu screen can be presented to the user 200. It is possible to reduce power consumption due to the refreshing process.

In the present embodiment, in a case where a state in which the user 200 does not view the electrophoretic panel 140 is determined on the basis of a body motion signal, the processing circuit 110 may perform a refreshing process.

For example, in the example illustrated in FIG. 18, in a case where a state in which the user 200 does not view the electrophoretic panel 140 is determined, the electrophoretic panel 140 performs white display indicated by AW and black display indicated by AB on the entire screen a predetermined number of times, and then performs display update to a screen including alarm information indicated by A13. Alternatively, in a case where a state in which the user 200 does not view the electrophoretic panel 140 is determined, the electrophoretic panel 140 performs a refreshing process on the entire screen, and then performs display update to a screen including alarm information indicated by A13. According thereto, for example, in a non-viewing state, or a state in which the user is supposed not to frequently view the wearable apparatus, the refreshing process can be performed. Consequently, it is possible to improve display quality without influencing display during viewing.

In the present embodiment, the processing circuit 110 may set arrangement of respective pixels in which an afterimage is unlikely to occur on the basis of arrangement of white pixels and black pixels forming display of the electrophoretic panel 140.

For example, in FIG. 19, a display region indicated by A14 has a menu screen configuration in which no margin is formed, and can realize menu display in which an afterimage is not visible. A display region indicated by A15 has a menu screen configuration in which a margin is formed. According thereto, for example, in a viewing state, or a state in which the user is supposed to frequently view the wearable apparatus, it is possible not to perform a refreshing process.

In the present embodiment, in a case where a settlement process is performed with a settlement terminal (not illustrated) by using settlement information, the processing circuit 110 may perform a refreshing process on the electrophoretic panel 140. The electrophoretic panel 140 may display settlement process progress information after the refreshing process is performed.

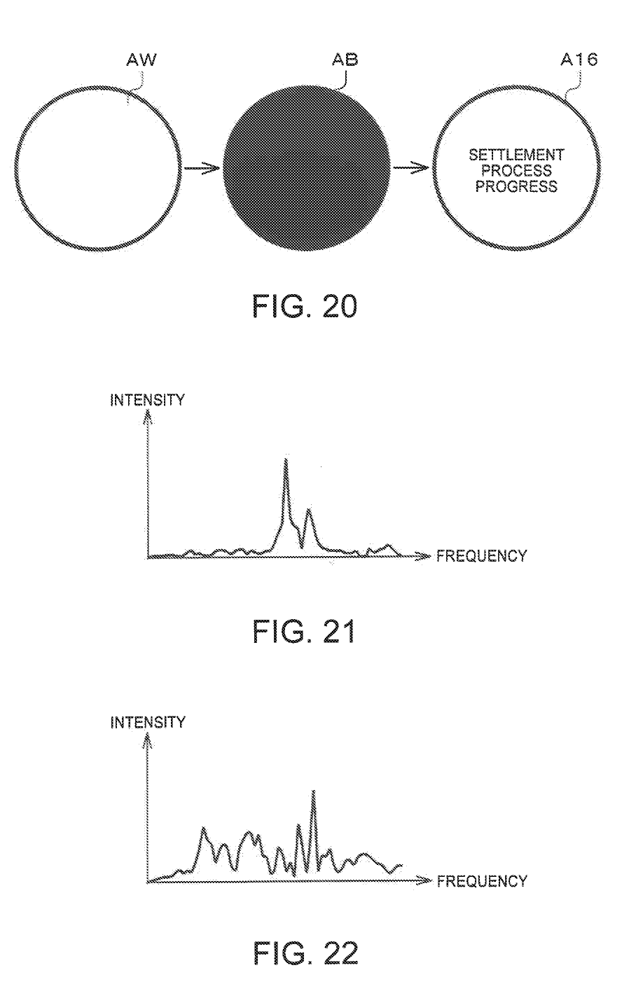

For example, in the example illustrated in FIG. 20, in a case where a settlement process is performed with a settlement terminal (not illustrated) on the basis of settlement information, the electrophoretic panel 140 performs white display indicated by AW and black display indicated by AB on the entire screen a predetermined number of times, and then performs display update to a screen including lap time information indicated by A16. Alternatively, in a case where a settlement process is performed with a settlement terminal (not illustrated) on the basis of settlement information, the electrophoretic panel 140 performs a refreshing process on the entire screen, and then performs display update to a screen including lap time information indicated by A16. According thereto, it is possible to efficiently and effectively perform a refreshing process on the electrophoretic panel at a meaningful timing such that the user does not suffer from stress. In other words, a refreshing process on the electrophoretic panel is not performed at a timing not intended by the user. Consequently, it is possible to improve display quality without influencing display during viewing. In a case where the processing circuit 110 is configured to perform a refreshing process when a settlement process is performed with a settlement terminal (not illustrated) by using settlement information, the refreshing process can suggest that the settlement process is being performed to the user 200, and thus the refreshing process can be performed at a meaningful timing.

In a case where a refreshing process is performed on the electrophoretic panel 140 right before a trigger of a refreshing process on the electrophoretic panel 140 occurs (for example, within one minute), a refreshing process on the electrophoretic panel 140 may not be performed at the timing. In other words, even if a trigger event in which refreshing is to be performed within a predetermined period occurs after a refreshing process is performed, refreshing caused by the trigger event may be restricted.

When the user 200 does not view a watch screen (in a non-viewing state), minimum required information may be displayed. In the non-viewing state, second display may be removed, and update may not be performed every second. In the non-viewing state, an image such as a screen saver may be displayed. Alternatively, in the non-viewing state, screen display may be removed. A region in which an afterimage remains may be estimated, and the region may be refreshed with a pinpoint.

In the above description, the configuration and the operation of the wearable apparatus 100 of the present embodiment have been described, but the technique may be executed as a control method for the wearable apparatus 100. In other words, the technique may be executed as a control method for the wearable apparatus 100 including the electrophoretic panel 140, and a control method of performing a refreshing process on the electrophoretic panel on the basis of at least one of a body motion signal and a communication signal. For example, each step is executed by the wearable apparatus 100 or the processing circuit 110.

A program according to the present embodiment is a program which is executed by the wearable apparatus 100 including the electrophoretic panel 140, and causes the wearable apparatus 100 to detect motion of the user 200, to output a body motion signal, to receive a communication signal from an external apparatus (not illustrated), and to perform a refreshing process on the electrophoretic panel 140 on the basis of at least one of the body motion signal and the communication signal.

In the above-described embodiment, the program executed by the wearable apparatus 100 may be stored in a computer readable storage medium such as a flexible disc, a compact disc read only memory (CD-ROM), a digital versatile disc (DVD), and a magneto-optical disc (MO) so as to be distributed, and may configure the wearable apparatus 100 by installing the program in a computer or the like.

In a case where processes for realizing an operation of the wearable apparatus 100 are shared and performed by respective operating systems (OSs), or are performed in cooperation between an OS and an application, only portions other than the OS may be stored in a medium so as to be distributed, and may be downloaded.

### 3. Method of Determining Activity State

Hereinafter, a description will be made of methods of determining (detecting) a daily life state and a workout state. Any of the methods described below may be used, and a combination of a plurality of methods may be used.

A first method is a method of performing determination by using the magnitude of acceleration measured by the acceleration sensor 120 and threshold values. In other words, in a case where the magnitude of acceleration is more than a first threshold value, a workout state (second state) is determined, and, in a case where the magnitude of acceleration is less than a second threshold value smaller than the first threshold value, a daily life state (first state) is determined.

A second method is a method of performing determination on the basis of a histogram of acceleration measured by the acceleration sensor 120. The histogram may be, for example, a histogram for the magnitude of acceleration, and may be a histogram for the magnitude and a direction of acceleration. For example, it is determined whether a peak of a histogram (acceleration with the maximum number of samples in the histogram) or a shape of a histogram satisfies a determination condition for a daily life state or a determination condition for a workout state.

A third method is a method of performing determination on the basis of a frequency characteristic of acceleration measured by the acceleration sensor 120. Herein, a workout state accompanied by periodic motion such as running or walking will be described as an example, but this is only an example, and this method may be applied in a case where frequency characteristics of acceleration are different from each other in a daily life state and a workout state.

FIG. 21 illustrates a frequency characteristic of acceleration measured in a workout state (second state). FIG. 22 illustrates a frequency characteristic of acceleration measured in a daily life state (first state). The frequency characteristics are obtained by performing Fourier transform on time-series accelerations measured by the acceleration sensor 120.

As illustrated in FIG. 21, in a workout state, there is periodicity in acceleration due to arm swinging in running or walking, and thus a frequency corresponding to the cycle has a peak in the frequency characteristic. The intensity (the magnitude of a frequency component) at the peak becomes much greater than intensities at other frequencies. On the other hand, as illustrated in FIG. 22, in a daily life state, periodicity of acceleration is small, and thus a difference between the intensity at the maximum peak in the frequency characteristic and the intensities at other frequencies is smaller than in a workout state. Such a difference is determined, and thus a daily life state and a workout state can be differentiated from each other. For example, in a case where a difference between the maximum peak and other peaks exceeds a threshold value, a workout state may be determined, or, in a case where there is a peak exceeding a threshold value, a workout state may be determined.

A fourth method is a method of determining that a state finally transitions in a case where a predetermined number of determinations is satisfied. In other words, in a daily life state, in a case where a workout state is determined N times, it is determined that transition to the workout state finally occurs. In a workout state, in a case where a daily life state is determined M times, it is determined that transition to the daily life state finally occurs. Any of the first to third methods may be used for each determination. Here, N and M are integers of 1 or greater, and N and M may or not be the same number.

In the above description, a description has been made of an example of a case where acceleration measured by the acceleration sensor 120 is used as an evaluation value of motion, but an evaluation value of motion is not limited thereto. For example, in a case where a gyro sensor is used as a body motion sensor, angular velocity may be used as an evaluation value of motion. Alternatively, a value obtained by processing acceleration or angular velocity may be used as an evaluation value of motion. Alternatively, the wearable apparatus 100 may include a pulse sensor (not illustrated), and a daily life state and a workout state may be determined on the basis of a pulse measured by the pulse sensor. It is determined whether or not the wearable apparatus 100 is detached from the body of the user 200 on the basis of an output signal from a “biological sensor” such as the pulse sensor 210.

Next, a description will be made of a method of determining (detecting) a non-viewing state and a viewing state. Hereinafter, a description will be made of an example of a case of using a determination method which is different from a method of determining a workout state and a daily life state, but this is only an example, and the same determination method (for example, detection based on an attitude of the wearable apparatus 100) as the method of determining a workout state and a daily life state may be used.

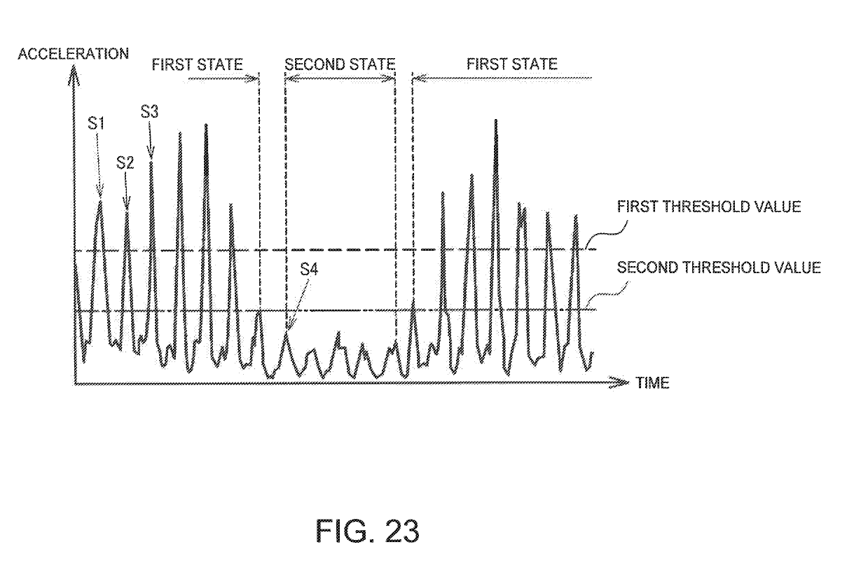

FIG. 23 is a graph for explaining a method of determining a non-viewing state and a viewing state in a workout state. In a workout state of performing running or walking, as indicated by S1 to S3 in FIG. 23, cyclic peaks occur in acceleration due to cyclic motion such as arm swinging. In a first state (non-viewing state) in which the user 200 swings the arms, a peak increases, and thus the first state (non-viewing state) is determined in a case where acceleration (a peak thereof) is more than a first threshold value. On the other hand, as indicated by S4, in a case where acceleration (a peak thereof) is less than a second threshold value, a second state (viewing state) is determined. The second threshold value is smaller than the first threshold value.

In a daily life state, the above periodicity of motion is not clear, and thus a non-viewing state and a viewing state are determined on the basis of an attitude of the wearable apparatus 100. For example, the acceleration sensor 120 is a sensor measuring accelerations in three axes such as XYZ. For example, the Z axis is an axis along a normal direction to the display surface of the electrophoretic panel 140, and the X axis and the Y axis are axes which are orthogonal to the Z axis and are orthogonal to each other. In a daily life state, acceleration due to motion is considered to be small, and thus accelerations in the three axes may be acceleration vectors of gravitational acceleration. A non-viewing state and a viewing state are determined on the basis of directions (angles formed between respective axes of XYZ and the acceleration vectors) of the acceleration vectors of the gravitational acceleration. In a case where the user 200 views the electrophoretic panel 140 in a standing state (in a state of raising at least the upper body), the display surface of the electrophoretic panel 140 is expected to be directed vertically upward (the gravitational acceleration is directed in the −Z direction). Thus, in a case where it is determined that the gravitational acceleration is included in a predetermined angle range centering on the −Z direction, a viewing state is determined.

As mentioned above, in the present embodiment, the processing circuit 110 determines an activity state on the basis of at least one of motion and an attitude of the wearable apparatus 100 worn by the user 200.

In the above-described way, it is possible to determine whether or not an activity state of the user 200 transitions from the first state to the second state on the basis of at least one of motion and an attitude of the wearable apparatus 100.

In the present embodiment, the processing circuit 110 determines that an activity state is a state in which the user 200 views the electrophoretic panel 140 on the basis of at least one of motion and an attitude of the wearable apparatus 100. In other words, when it is determined that the user 200 is in a state of viewing the electrophoretic panel 140 on the basis of at least one of motion and an attitude of the wearable apparatus 100, the processing circuit 110 determines that an activity state is the second state.

In other words, in a case where at least one of motion and an attitude satisfies a predetermined condition when the user 200 views the electrophoretic panel 140, and it is determined that at least one of the motion and the attitude satisfies the predetermined condition, the processing circuit 110 determines that the activity state is the second state.

In the above-described way, it is possible to determine whether or not an activity state of the user 200 has transitioned to the second state which is a viewing state.

According to the present embodiment, it is possible to efficiently and effectively perform a refreshing process on the electrophoretic panel 140 at a meaningful timing such that the user 200 does not suffer from stress. In other words, a refreshing process on the electrophoretic panel 140 is not performed at a timing not intended by the user 200. Consequently, it is possible to improve display quality without influencing display during viewing. In a case where the processing circuit 110 is configured to perform a refreshing process on the basis of detection of either of a body motion signal and a communication signal, the refreshing process can suggest, for example, a determination result based on the body motion signal or reception of the communication signal to the user 200, and thus the refreshing process can be performed at a meaningful timing.

Although the present embodiment has been described as above in detail, it can be easily understood by a person skilled in the art that various modifications without substantially departing from the new matters and effects of the disclosure are possible. Therefore, these modifications are all included in the scope of the disclosure. For example, in the specification or the drawings, the terminologies which are mentioned at least once along with different terminologies which have broader meanings or the same meanings may be replaced with the different terminologies in any location of the specification or the drawings. All combinations of the present embodiment and the modification examples are included in the scope of the disclosure. In addition, configurations or operations of the processing circuit, the wearable apparatus, and the like, or control methods for the wearable apparatus are also not limited to the above description of the present embodiment, and may have various modifications.

What is claimed is:

1. A portable electronic apparatus comprising:
an electrophoretic panel;
a body motion sensor that detects motion of a user, and outputs a body motion signal;
a communication circuit that receives a communication signal from an external apparatus; and
a processing circuit that is electrically connected to the electrophoretic panel, the body motion sensor, and the communication circuit,
wherein the processing circuit performs a refreshing process on the electrophoretic panel on the basis of either of the body motion signal and the communication signal.

2. The portable electronic apparatus according to claim 1,
wherein, in a case where a lap separation position is determined on the basis of the body motion signal, the processing circuit performs the refreshing process.

3. The portable electronic apparatus according to claim 1,
wherein the communication signal includes at least one of reception of a call, reception of an electronic message, a notification of a schedule, and reception of music data, and
wherein, in a case where the communication circuit receives the communication signal, the processing circuit performs the refreshing process.

4. The portable electronic apparatus according to claim 1,
wherein, in a case where it is determined that target information related to a workout performed by the user has been achieved on the basis of the body motion signal, the processing circuit performs the refreshing process.

5. The portable electronic apparatus according to claim 1,
wherein, in a case where it is determined that the portable electronic apparatus has transitioned to a movement state from a standing still state on the basis of the body motion signal, the processing circuit performs the refreshing process.

6. The portable electronic apparatus according to claim 1,
wherein, in a case where it is determined that the portable electronic apparatus has been detached from the user's body on the basis of the body motion signal, the processing circuit performs the refreshing process.

7. The portable electronic apparatus according to claim 1,
wherein, in a case where a change in a behavior type of the user is detected on the basis of the body motion signal, the processing circuit performs the refreshing process.

8. The portable electronic apparatus according to claim 1, further comprising:
a GNSS signal reception circuit that receives a GNSS signal,
wherein, in a case where the GNSS signal including a measurement is received by the GNSS signal reception circuit, the processing circuit performs the refreshing process.

9. The portable electronic apparatus according to claim 1, further comprising:
a pulse sensor that measures a pulse signal,
wherein, when measuring the pulse signal in the pulse sensor, the processing circuit performs the refreshing process.

10. The portable electronic apparatus according to claim 1, further comprising:
a charging terminal that is connected to a charger,
wherein, in a case where it is determined that connection between the charging terminal and the charger has been terminated, the processing circuit performs the refreshing process.

11. The portable electronic apparatus according to claim 1, further comprising:
a clock that measures time,
wherein, in a case where a time measured from the clock increases by an hour, or a split time increases by an hour, the processing circuit performs the refreshing process.

12. The portable electronic apparatus according to claim 1, further comprising:
an operation device that receives an operation of the user, and outputs an operation signal,
wherein, in a case where the operation signal from the operation device is detected, the processing circuit performs the refreshing process.

13. The portable electronic apparatus according to claim 12,
wherein, in a case where the operation signal corresponding to at least one of a menu screen transition operation and a lock function ON/OFF operation is detected, the processing circuit performs the refreshing process.

14. The portable electronic apparatus according to claim 1,
wherein, when display of the electrophoretic panel is switched from a first screen to a second screen, the electrophoretic panel leaves at least a partial outline of an object included in the first screen, and displays the partial outline and the second screen together.

15. The portable electronic apparatus according to claim 1,
wherein the processing circuit controls content for display, and, in a case where the processing circuit detects a change in the content for display from first content to second content, the processing circuit performs the refreshing process.

16. The portable electronic apparatus according to claim 1,
wherein, in a case where it is determined that the user is in a state of not viewing the electrophoretic panel on the basis of the body motion signal, the processing circuit performs the refreshing process.

17. A portable electronic apparatus comprising:
an electrophoretic panel;
a memory that stores settlement information;
a communication device that communicates with a settlement terminal; and
a processing circuit that is electrically connected to the electrophoretic panel, the memory, and the communication device,
wherein, in a case where a settlement process is performed with the settlement terminal by using the settlement information, the processing circuit performs a refreshing process on the electrophoretic panel.

18. A control method for a portable electronic apparatus including an electrophoretic panel, the control method comprising:
detecting motion of a user, and outputting a body motion signal;
receiving a communication signal from an external apparatus; and
performing a refreshing process on the electrophoretic panel on the basis of either of the body motion signal and the communication signal.

19. A non-transitory computer readable medium storing a program executed by a portable electronic apparatus including an electrophoretic panel, the program causing the portable electronic apparatus to execute
detecting motion of a user, and outputting a body motion signal;
receiving a communication signal from an external apparatus; and
performing a refreshing process on the electrophoretic panel on the basis of either of the body motion signal and the communication signal.

20. A portable electronic apparatus comprising:
a electrophoretic display panel;
a sensor;
a communication circuit; and
a processor programmed to
perform a refreshing process on the electrophoretic display panel based on a signal from either the sensor or the communication circuit.

21. The portable electronic apparatus according to claim 20,
wherein the refreshing process includes a process of performing monochrome display.

22. The portable electronic apparatus according to claim 20,
wherein the processor performs the refreshing process based on at least one of an intensity and a frequency of a signal outputted from the sensor.
